(19) United States
(12) Patent Application Publication
(10) Pub. No.: US 2008/0315827 A1
(43) Pub. Date: Dec. 25, 2008

(54) Air turbine

(76) Inventor: Steven Ray Massey, Cartersville, GA (US)

Correspondence Address: Steven R. Massey, 15 Southview Drive, Cartersville, GA, 30121, US

(21) Appl. No.: 11/786,407

(22) Filed: Jun. 21, 2007

(51) Int. Cl. H01M 10/44

(52) U.S. Cl. 320/101

(57) ABSTRACT

A electrical generating device installed in an electric vehicle for the purpose of charging direct current batteries. The device being encased in a housing, can be installed behind the nose or front grill section of an electric vehicle. The front section of the device consists of an air intake, which directs high wind speed directly into a pivotal air turbine, which surrounds and connects a shaft. Attached to the shaft is a pulley that is connected to a pulley mounted on an electric generating device with the means of a rotational energy connecting element, thereby resulting in wind powered electrical generation for electric vehicles while in motion.

This invention relates to air powered electrical generation for electric vehicles while in motion.

### BACKGROUND OF THE INVENTION

After much research on existing electric vehicles, the distance most can travel is approximately one hundred miles between re-charging of the direct current batteries. While this may seem good it limits its potential to short commutes.

There are many proposals to this problem of improving the distance of travel:

(a) Installing an electric grid in one lane of interstate highways. This would be costly as well as inconvenient for the department of transportation.

(b) Fitting the electric vehicle with a pull behind trailer which carries a gas driven generator. While this would increase the distance, the cost of travel would increase due to gas being consumed by the generator. I can also see problems of parking with a pull behind trailer, since many people would find this difficult.

(c) Existing electric vehicles do have a braking system that when applied reverses the direct current motor which generates a small electrical charge to the direct current batteries. However, they only have a distance of approximately one hundred miles between re-charges.

### BACKGROUND OF INVENTION—OBJECTS AND ADVANTAGES

Accordingly, several objects and advantages of my invention are:

(a) to provide self-sustained electrical generation for direct current batteries in an electric vehicle without relying upon an energized grid in a roadway surface.

(b) to provide a method of producing electrical energy to an electric vehicle that is concealed within itself, without the necessity of towing auxiliary equipment.

(c) to provide a method of producing electrical energy in an electric vehicle while in motion, instead of limiting electrical energy production to the braking system.

Further objects and advantages are that it takes advantage of high wind speeds that would otherwise be lost. Since all vehicles travel at speeds of fifty five to seventy miles per hour on highways, we could harness this valuable energy resource. Wind mill locations do not have access to this constant high wind velocity created naturally while driving. Every time air speed doubles it increases eight times in strength. Unlike a conventional wind mill, the air turbine will not furl, but instead after consuming air it will then expel the air at a downward angle. By installing an angled plate on the frame of the vehicle, the air could be displaced on the bottom of each side of the vehicle. The vehicles on aerodynamics would create an air draw, thus improving the overall efficiency of the invention, resulting in air being consumed and discharged with similar velocity. The air turbine has over twenty three hundred square inches of blades exposed to this high wind speed.

There is an air intake which slopes inwardly, and discreetly sets in front of the air turbine which funnels air in three directions. This directional wind corresponds to the angle of the blades of the air turbine, thus creating a turbine of high torque. The air turbine rotates on a shaft that has a pulley attached to one side. Attached to this pulley is a belt that is also connected to a smaller pulley that is connected to an electrical generator. This ratio created by two different pulley sizes allows the generator more revolutions per minute as compared to the air turbine, thus increasing electrical generation output. Other applications could be a direct drive shaft from the air turbine to the electrical generator.

The air turbine can be installed discreetly in the nose section of the vehicle. Since electric vehicles have no need for a cooling radiator this seems appropriate for the invention to be located. This location is also beneficial since the air intake would consume the air normally used for cooling the radiator, thus this invention would be concealed under the hood of the vehicle. Further objects and advantages of my invention will become apparent from a consideration of the drawings and ensuing description and drawings.

### SUMMARY

The air turbine is a machine specially built for the purpose of charging direct current batteries in an electric vehicle while in motion.

### DRAWING—FIGURES

In the drawings, page 1/7 gives an end and overhead view of the air turbine assembly, complete with figures. Supporting pages show figures separately.

FIG. 1 on page 1/7 shows an over head view of the air turbine housing.

FIG. 1 on page 2/7 shows a back, end and overhead view of the air turbine housing with through-notch and through-holes.

FIG. 2 on page 1/7 shows an overhead view of two air turbines.

FIG. 2 on page 3/7 shows an overhead and end view of a single air turbine.

FIG. 3 on page 1/7 shows an end view of the stationary deflector of the air intake.

FIG. 3 on page 4/7 shows a front, back and end view of the stationary deflector of the air intake.

FIG. 4 on page 1/7 shows an end view of the adjustable deflector of the air intake.

FIG. 4 on page 5/7 shows a front, back and end view of the adjustable deflector of the air intake, with through-notch.

FIG. 5 on page 1/7 shows an overhead view of the generator mount frame.

FIG. 5 on page 6/7 shows a back, end and overhead view of the generator mount frame, with through-holes.

FIG. 6 on page 1/7 shows an overhead view of the air turbine shaft.

FIG. 6 on page 7/7 shows an overhead view of the air turbine shaft, with keys.

FIG. 7 on page 1/7 shows an overhead view of a bearing connected to the air turbine shaft.

FIG. 8 on page 1/7 shows an overhead view of a pulley connected to the air turbine shaft.

FIG. 9 on page 1/7 shows an overview of a pulley connected to an electrical generating device.

FIG. 10 on page 1/7 shows an end view of a rotational energy connecting element.

FIG. 11 on page 1/7 shows an end view of an electrical generating device.

### DRAWINGS—REFERENCE NUMERALS

14 shaft opening

15 bearing mounted (through-holes)

18 through-notch

20 air turbine housing (through-holes)

22 coupling

24 bolt

26 generator mount frame (through-holes)

28 electrical generator mount (through-holes)

30 key

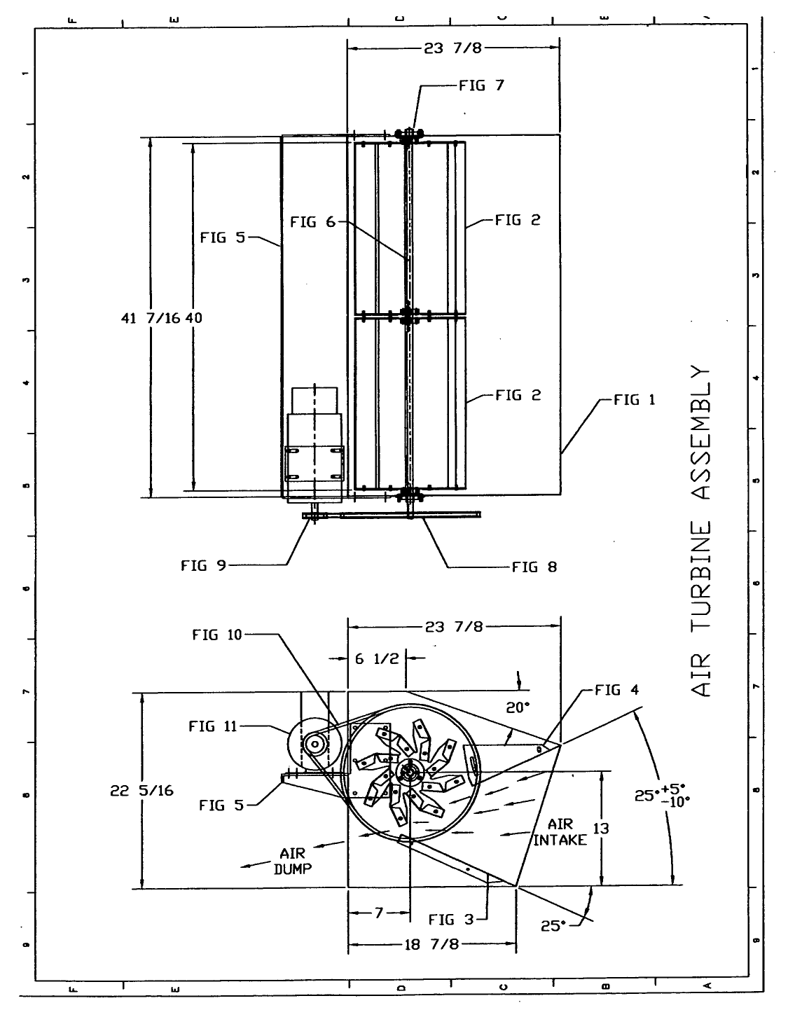

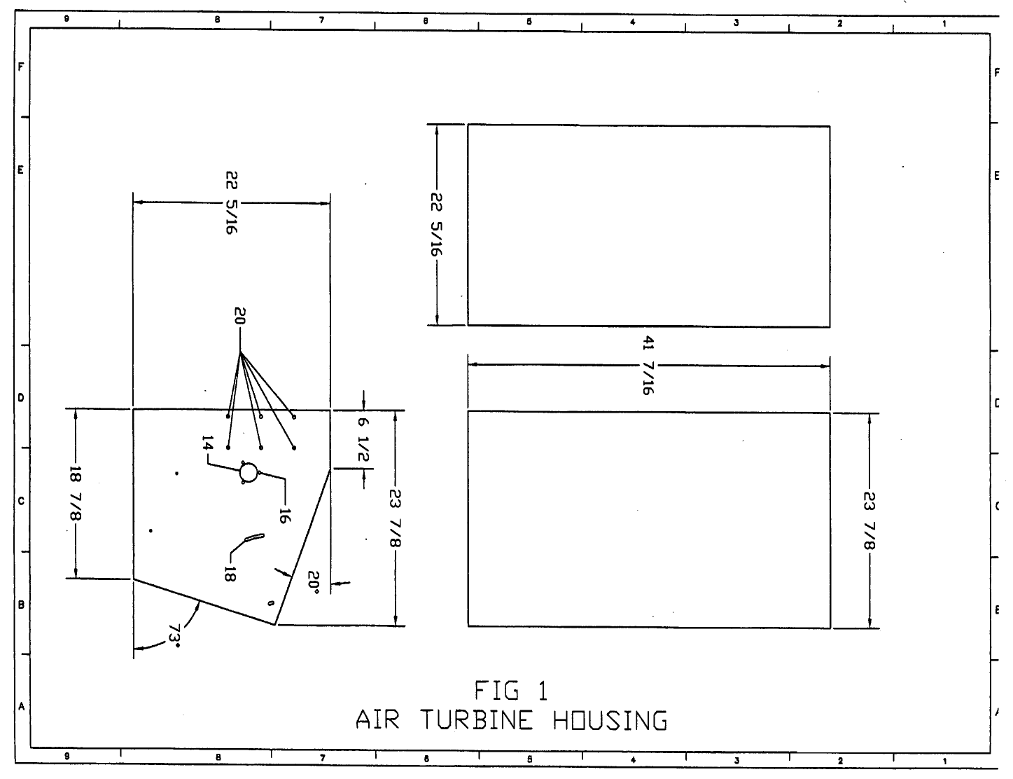

### DESCRIPTION—FIGS. 1-11—PREFERRED EMBODIMENT

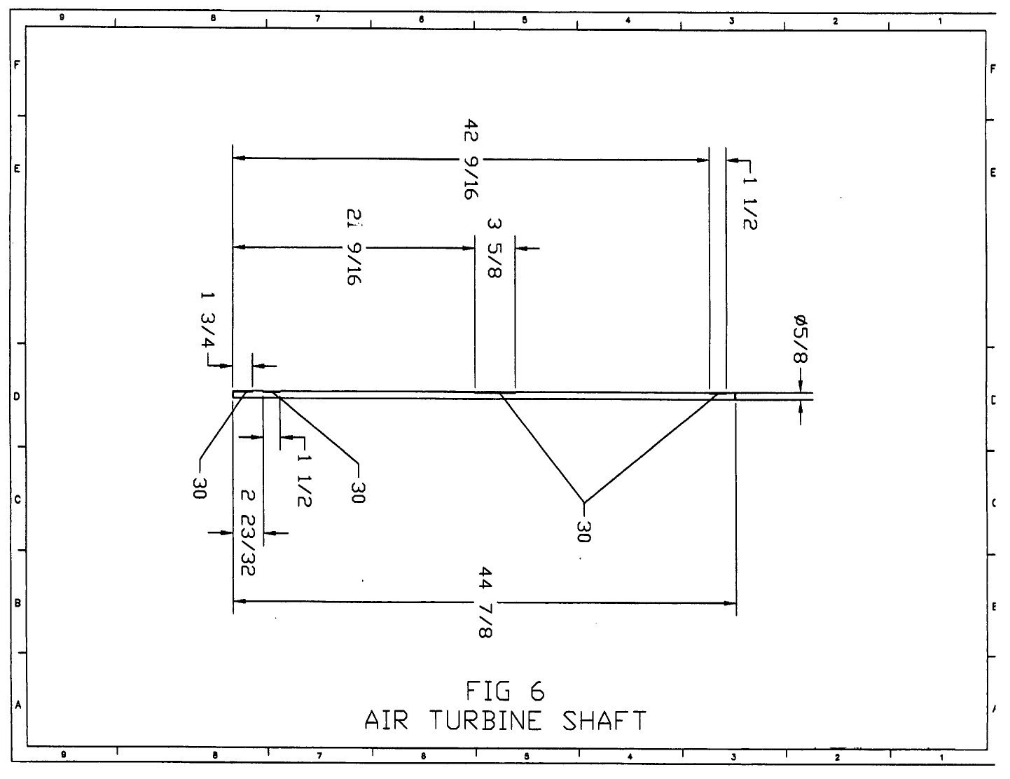

A preferred embodiment structure of the present invention is illustrated on page 1/7 (top view) and (end view) of the air turbine assembly. Page 1/7 (FIG. 7) shows a bearing mounted on each end of the housing on page 1/7 (FIG. 1). Page 2/7 (FIG. 1) (end view) shows 16 located on each end of the air turbine housing. Page 1/7 (FIG. 6) shows a shaft aligned horizontally and supported by bearings on page 1/7 (FIG. 7). Page 2/7 (FIG. 1) (end view) shows shaft placement through the housing 14. Page 1/7 (FIG. 2) shows two air turbines mounted on each end respectively with couplings 22 on page 3/7 (FIG. 2). Page 1/7 (FIG. 6) shows shaft surrounded by two air turbines on page 1/7 (FIG. 2) and being colligated to shaft on page 1/7 (FIG. 6) by couplings 22 on page 3/7 (FIG. 2) and keys 30 on page 7/7 (FIG. 6). Page 1/7 (FIG. 2) shows two air turbines colligated together by bolts 24 on page 3/7 (FIG. 2). Page 1/7 (FIG. 2) (top view) shows two air turbines colligated. In the preferred embodiment, the housing, air intake and air turbine blades are made of heavy gauge stainless steel. The air turbine shaft is made of high tempered steel due to the force applied on it.

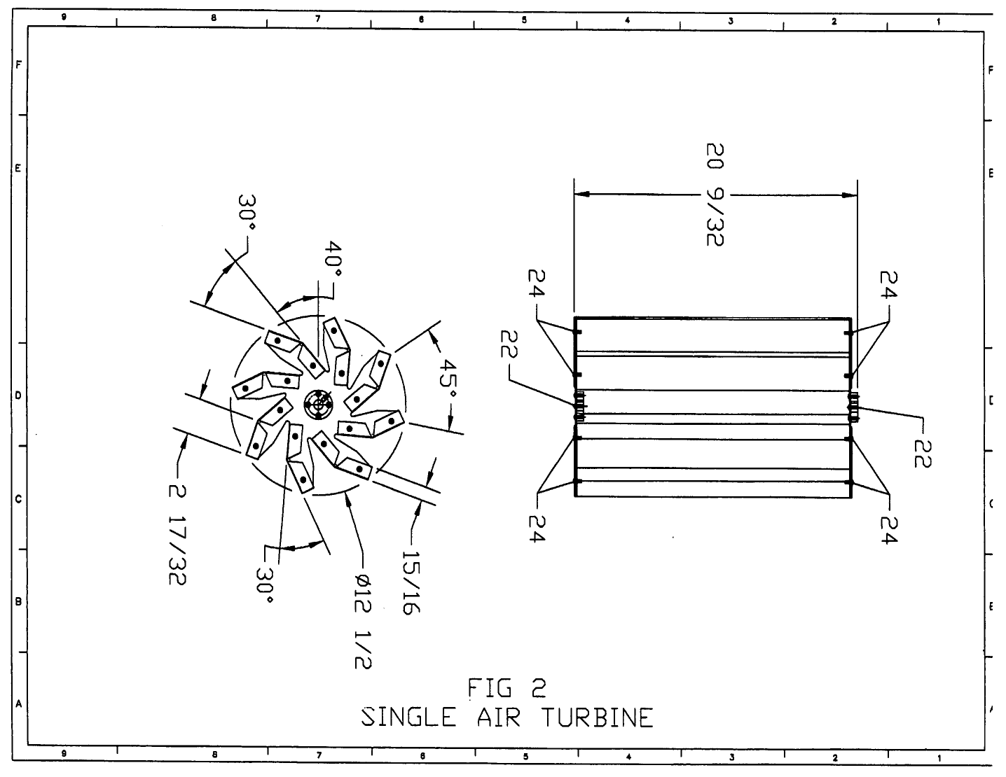

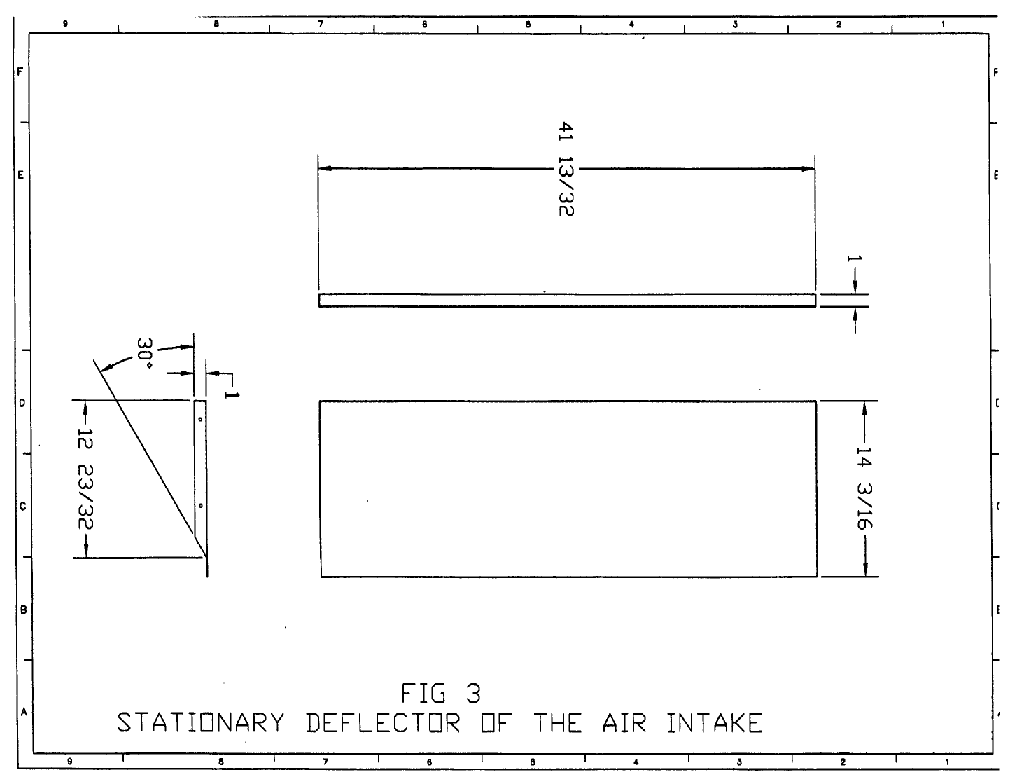

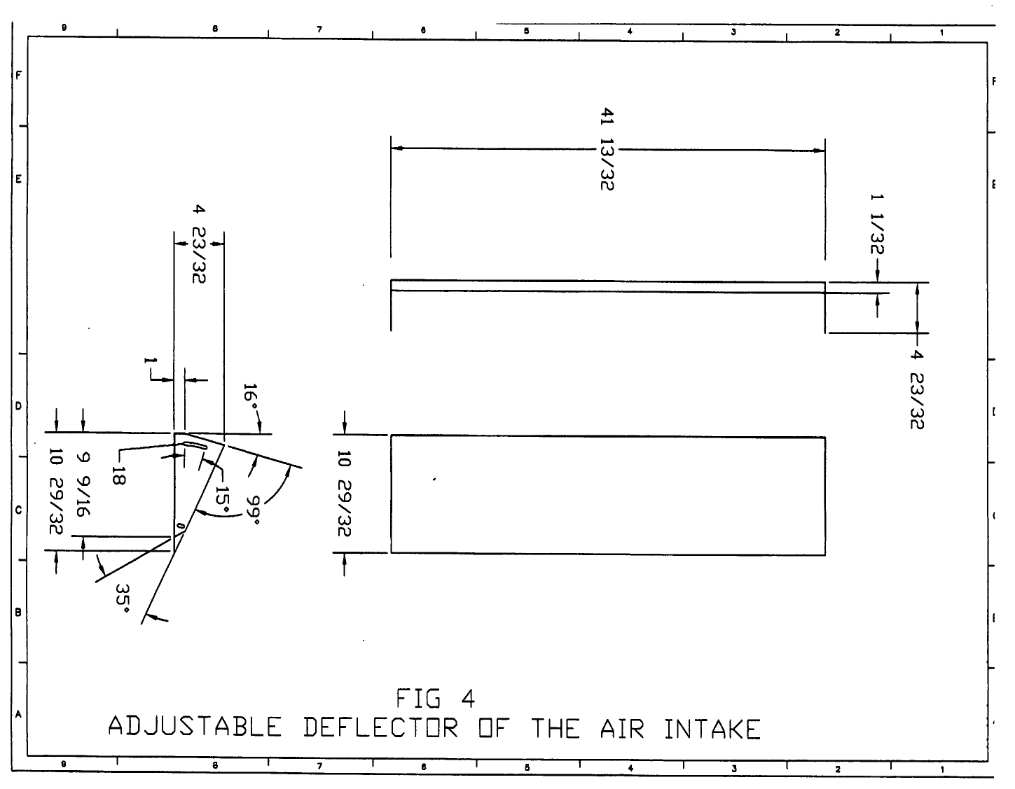

Page 1/7 (FIG. 3) and (FIG. 4) (end view) shows the air intake extended in front of the air turbines. Page 1/7 (FIG. 3) (end view) shows a stationary deflector composing the bottom section of the air intake. Page 1/7 (FIG. 4) (end view) shows a adjustable deflector composing the top section of the air intake. Page 5/7 (FIG. 4) (end view) shows a through-notch 18 used to adjust deflector as needed.

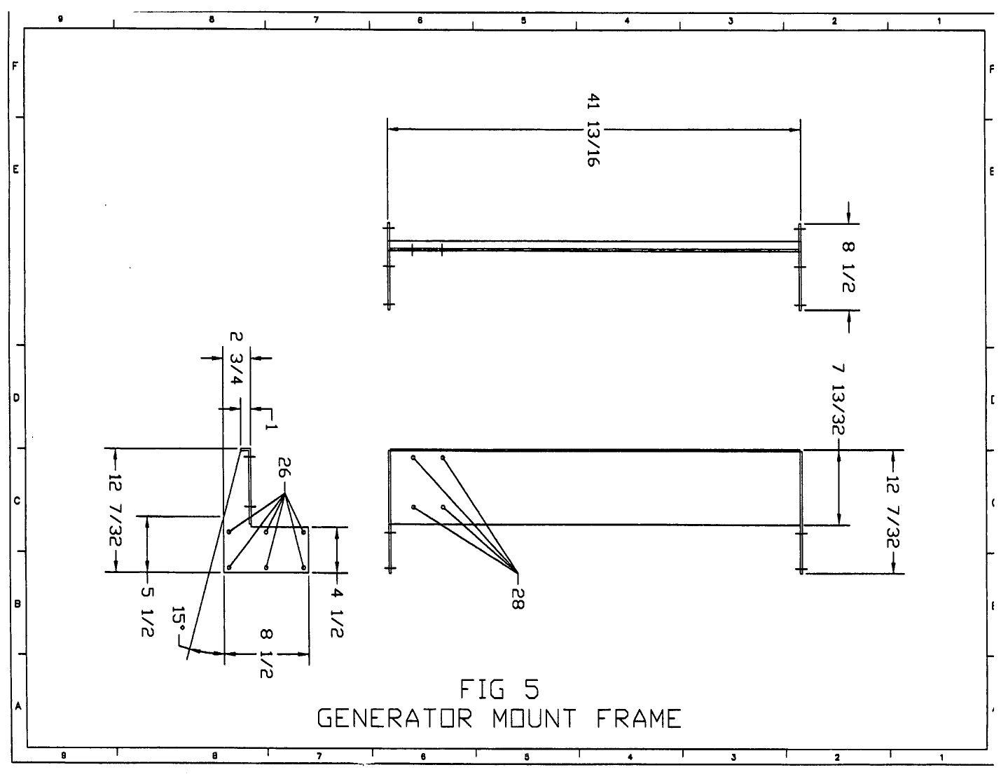

Page 1/7 (FIG. 8) (top view) shows a pulley mounted to one end of the shaft on page 1/7 (FIG. 6). Page 1/7 (FIG. 11) (end view) shows an electrical generating device containing a pulley on page 1/7 (FIG. 9) (top view). Page 1/7 (FIG. 10) (end view) shows a rotational energy connecting element connecting the two pulleys on page 1/7 (FIG. 8) and (FIG. 9) (top view). Page 1/7 (FIG. 11) (end view) shows a electric generating device being supported by a generator mount frame on page 1/7 (FIG. 5) (end view) which is connected to both sides of the housing at through-holes 20 on page 2/7 (FIG. 1) (end view) and through-holes 26 on page 6/7 (FIG. 5) (end view). Page 1/7 FIG. 11) (end view) shows electrical generating device is mounted at through-holes 28 on page 6/7 (FIG. 5) (top view).

### OPERATION—FIGS. 1,2,3,4,6,7,8,9,10,11

The function of using the air turbine as a means for generating electrical energy can begin with the air intake on page 1/7 (FIGS. 3 and 4) (end view). The air intake receives high wind speed, which is processed in three directions. Page 1/7 (FIG. 3) shows a stationary deflector composing the bottom section of the air intake which disperses the air flow at an elevated pitch. Page 1/7 (FIG. 4) shows an adjustable deflector composing the top section of the air intake which disperses the air flow downward. Wind not affected by the deflectors would then be received as a straight line air flow.

As shown on page 1/7 (FIG. 2) (top and end view) the air turbine is capable of receiving directional wind with its angled blades shown on page 3/7 (FIG. 2) (top and end view).

Page 1/7 (FIG. 6) (top view) shows a pivotal shaft which is surrounded and colligated by the air turbines on page 1/7 (FIG. 2) (top view) with the use of couplings 22 on page 3/7 (FIG. 2) (top view) and keys 30 on page 7/7 (FIG. 6) (top view). This pivotal device is supported and rotates with the use of bearings on page 1/7 (FIG. 7) (top view) on each end. Page 1/7 (FIG. 7) (top view) shows bearings mounted on each side of the air turbine housing on page 1/7 (FIG. 1) (top view). This mounting and colligated process insures the stability of the air turbine while processing excessive wind speeds.

The rotational speed achieved from the shaft is transferred to a large pulley shown on page 1/7 (FIG. 8) (top view) thereby transferring rotation from the shaft to the pulley. A smaller pulley which is mounted to an electrical generating device on page 1/7 (FIGS. 9 and 11) (top and end view), is connected to the larger pulley with the means of a rotational energy connecting element on page 1/7 (FIG. 10) (end view), which then generates electrical energy from a generating device on page 1/7 (FIG. 11) (end view). Electrical energy produced is then used to charge direct current batteries of an electric vehicle.

### Advantages

From the description above, a number of advantages of my air turbine generator become evident.
(a) A valuable energy source can be used in an environmentally friendly process.
(b) The angled blades of the air turbine correspond to the wind direction, created by the air intake, resulting in a device of high torque capable of producing electrical energy efficiently from a wind source.
(c) The air turbine will provide a means for increasing the distance an electric vehicle can travel before re-charging.
(d) The air turbine assembly is enclosed by the housing, which can easily adapt into existing electric vehicles.
(e) The adjustable deflector can be moved so that it can direct air flow according to a vehicles particular needs.

### CONCLUSION RAMIFICATION AND SCOPE

Thus the reader, will see that the air turbine of this invention provides electrical generation from a wind source naturally obtained from a vehicle in motion. This wind source is received by the air intake, which is inwardly sloped so that to process wind from three directions into air turbines angled blades, thus consuming high wind speeds to be converted into electrical energy.

Connecting the air turbine to a generator is a rotational energy connecting element, which converts, wind power into useful electrical energy, to be consumed by direct current batteries. Furthermore, the air turbine has the additional advantages in that
it provides electrical energy in a environmentally friendly process;
it provides electrical energy to be produced at no cost;
it permits further distance of travel of electric vehicles; and
it provides more flexibility of electric vehicles with longer distance of travel between re-charging.

Although the description above contains many specificities, these should not be construed as limiting the scope of the invention but as merely providing illustrations of some of the presently preferred embodiments of this invention. For example, the air turbine can provide electrical energy in any type vehicle, vessel or craft so equipped to carry the invention. Electrical energy produced by the air turbine can be stored into direct current batteries for later use.

Thus the scope of the invention should be determined by the appended claims and their legal equivalents, rather than by the examples given.

I claim:

1. A means for charging direct current batteries in an electric vehicle, comprising:
(a) a air turbine having a air intake device being joined to said air turbines face,
(b) a rotational energy connecting element, connected to said air turbines breech, and a generating device,
(c) whereby said generating device will charge direct current batteries

2. The means of claim 1 wherein said air turbine is pivotal.

3. Further including, the means of claim 1 wherein said air turbine is surrounding and connecting a shaft.

4. The means of claim 1 wherein said air turbine is separated into two equal sections on said shaft.

5. The means of claim 1 wherein said air turbine sections are colligated.

6. The means of claim 1 wherein said air turbine has multiple angled blades.

7. Further including, the means of claim 1 wherein said shaft has a pulley mounted on said shaft edge.

8. Further including, the means of claim 1 wherein said generating device has a pulley mounted on said generating device edge.

9. The means of claim 1 wherein said rotational energy connecting element is mounted to said pulley of said shaft and to said pulley of said generating device.

10. The means of claim 1 wherein said air intake device face is sloped inward.

11. Further including, the means of claim 1 wherein said air intake has a adjustable deflector positioned on top.

12. Further including, the means of claim 1 wherein said air intake has a stationary deflector positioned on bottom.

13. Further including, said air turbine is surrounded by a air turbine housing.
